(19) United States
(12) Patent Application Publication
(10) Pub. No.: US 2019/0279485 A1
(43) Pub. Date: Sep. 12, 2019

(54) METHOD AND APPARATUS TO DETECT UNAUTHORIZED PHYSICAL PRESENCE BASED ON WIRELESS ACTIVITY

(71) Applicant: Lenovo (Singapore) Pte. Ltd., New Tech Park (SG)

(72) Inventors: Russell Speight VanBlon, Raleigh, NC (US); John Carl Mese, Cary, NC (US); Nathan J. Peterson, Oxford, NC (US)

(21) Appl. No.: 15/917,937

(22) Filed: Mar. 12, 2018

(51) Int. Cl. G08B 21/22; G08B 13/22; H04W 12/08; H04W 4/021; H04W 4/029; G07C 9/00

(52) U.S. Cl. CPC G08B 21/22; G08B 13/22; G07C 9/00111; H04W 4/021; H04W 4/029; H04W 12/08

(57) ABSTRACT

A computed implemented method, apparatus and computed program product are provided that, under control of one or more processors configured with executable instructions, detect wireless activity of a mobile device in proximity to a local environment. The method, apparatus and computed program product track a detected path of the mobile device based on one or more characteristics of a signal broadcast from the mobile device, determine whether the detected path of the mobile device indicates an unauthorized physical presence relative to a restricted zone related to the local environment and output an alert when the detected path indicates the unauthorized physical presence of the mobile device relative to the restricted zone.

### FIELD

The present disclosure relates generally to detecting an unauthorized physical presence, and more particularly to tracking a physical presence of wireless devices based on the wireless activity.

### BACKGROUND OF THE INVENTION

Security systems today utilize various types of devices to collect video and audio information in connection with monitoring an area. For example, home and commercial security systems utilize motion detectors, video cameras, door and window sensors, glass break detectors, etc., to monitor entry to (and a presence in) a home, office, property and the like.

However, many conventional security systems only identify an unauthorized entry after an individual has entered a monitored area. Conventional security systems cannot determine when an unauthorized individual approaches a monitored area, but then leaves without actually entering the monitored area (e.g., when a potential burglar is “casing” a home or office for a later time).

Some conventional systems utilize motion sensors and video monitoring cameras positioned outside of a premise to detect individuals approaching the premise. However, not every individual, who approaches a premise, is a potential thief or has an improper motive. Motion sensors and video monitoring cameras are unable to differentiate between normal/acceptable activity (e.g., homeowners, family, neighbors, friends, delivery personnel, employees) and abnormal/unacceptable activity of unauthorized individuals.

Also, conventional security systems offer limited mechanisms for determining whether an individual, who has entered a restricted zone, is an authorized or unauthorized individual. For example, a determination that an entry is authorized may be based on inputting a key code at a control panel, scanning an RFID tag, voice recognition, facial recognition and the like. Systems that require a key code or RFID tag create an opportunity for unauthorized individuals to gain access by learning the key code and/or stealing an RFID tag. Recognition systems, such as for voice and facial features, are complex, expensive and not entirely reliable in certain environments.

### SUMMARY

In accordance with embodiments herein, a method is provided. The method is under control of one or more processors configured with executable instructions. The method detects wireless activity of a mobile device in proximity to a local environment. The method tracks a detected path of the mobile device based on one or more characteristics of a signal broadcast from the mobile device, determines whether the detected path of the mobile device indicates an unauthorized physical presence relative to a restricted zone related to the local environment and generates an alert when the detected path indicates the unauthorized physical presence of the mobile device relative to the restricted zone.

Optionally, the determining may comprise determining whether the detected path of the mobile device crosses a boundary of the restricted zone. The detecting may comprise detecting a wireless signature (WLS) of the mobile device, where the WLS may be assigned a limited access authorization level. The determining may comprise determining whether the detected path follows a limited access route corresponding to the limited access authorization level. The determining may comprise comparing the detected path to one or more predetermined routes associated with the restricted zone. The detecting, tracking and determining may be performed in association with denying the mobile device. The mobile device may be one or more of a phone, wearable device or tablet device. The detecting may comprise detecting a request to connect from the mobile device. The request to connect may include the WLS for the mobile device. The determining may comprise characterizing the detected path as normal activity or abnormal activity.

In accordance with embodiments herein, an apparatus is provided. The apparatus includes a tracking circuit that detects wireless activity of a mobile device in proximity to a local environment. The tracking circuit tracks a detected path of the mobile device based on one or more characteristics of a signal broadcast from the mobile device. The apparatus includes a processor, and a memory storing program instructions accessible by the processor. In response to execution of the program instructions, the processor determines whether the detected path of the mobile device indicates an unauthorized physical presence relative to a restricted zone related to the local environment and generates an alert when the detected path indicates the unauthorized physical presence of the mobile device relative to the restricted zone.

Optionally, the one or more processors may store and manage one or more of tracking records, a learning log and/or an activity log. The tracking records may be associated with tracking events for the mobile device and the corresponding WLS. The learning log may define a restricted zone in connection with the local environment. The restricted zone may correspond to a predetermined route. The activity log may maintain access authorization levels assigned to individual WLS. An activity history and the access authorization levels may include one or more of complete access, full exterior access, entry area access, delivery route access, garbage route access, utility route access and no access. The one or more processors may determine whether the detected path follows a limited access route corresponding to a limited access authorization level. The device may comprise a network transceiver to communicate with a wireless network. The one or more processors may detect, within the wireless activity, a request to connect from the mobile device. The request to connect may include the WLS for the mobile device.

In accordance with embodiments herein, a computer program product is provided comprising a non-signal computer readable storage medium comprising computer executable code to detect wireless activity of a mobile device in proximity to a local environment. The computer executable code tracks a detected path of the mobile device based on one or more characteristics of a signal broadcast from the mobile device, determines whether the detected path of the mobile device indicates an unauthorized physical presence relative to a restricted zone related to the local environment and generates an alert when the detected path indicates the unauthorized physical presence of the mobile device relative to the restricted zone.

Optionally, the computer executable code may further characterize the detected path as normal activity or abnormal activity. The computer executable code may further compare the detected path to one or more predetermined routes associated with the restricted zone. The computer executable code may the detect, track and determine are performed in association with denying the mobile device access to a wireless network.

### BRIEF DESCRIPTION OF THE DRAWINGS

FIG. 1 is a functional block diagram illustrating a local wireless environment that is tracked in accordance with embodiments herein.

FIG. 2 illustrates a block diagram of a WLA tracking apparatus formed in accordance with embodiments herein.

FIG. 3 illustrates a process for detecting an unauthorized physical presence based on wireless activity in accordance with embodiments herein.

FIG. 4 illustrates a process for learning normal and abnormal wireless activity in accordance with embodiments herein.

FIG. 5 is a block diagram of components of WLA tracking apparatus in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

### Definitions

The term “wireless mobile device”, as used throughout, shall include (but not be limited to) any device that is mobile and utilizes a wireless transmitter to establish at least a one-way communication session. The transmitter may represent a one-way transmitter, a transceiver and the like. The transceiver may be a cellular transceiver, a GPS transceiver, or any other type of transceiver capable of communication over a wireless network. As non-limiting examples, the device may be a sensor, Fitbit device, cellular phone, smart watch, wireless/cellular enable vehicles, portable computing devices and any other device that is mobile and able to establish at least a one-way communication session. The computing device can be a laptop computer, tablet computer, netbook computer, personal computer (PC), a desktop computer, a personal digital assistant (PDA), a smart phone, or any programmable electronic device capable of wireless communication.

The terms “wireless signature” and “WLS” as used herein, refer to information transmitted from a mobile wireless device that identifies the mobile device. The wireless signature or WLS may uniquely identify the mobile wireless device from other mobile wireless devices. For example, the WLS may represent a serial number, SSID, telephone number, MAC address, or other unique for a physical mobile wireless device, an operating system and/or software application running on the device. Additionally or alternatively, the wireless signature or WLS may not be a uniquely ID for the mobile device, but instead identify the mobile device to be within a type or class of mobile devices. For example, a GPS transmitter may transmit a wireless signature that indicates that the mobile device is a GPS transmitter (and not a cellular transmitter).

The term “broadcast signal”, as used herein, refers to a signal transmitted by a transmitter of a wireless mobile device prior to, and/or independent of, establishing access to a wireless network and/or establishing a communications session. The broadcast signal may be transmitted in connection with an attempt to establish a communications session, such as by a Bluetooth, cellular or WiFi transceiver. For example, the broadcast signal may represent an advertisement or connection request transmitted over one or more broadcast channels in accordance with a cellular or other wireless protocol. Optionally, the broadcast signal may not be transmitted in connection with an attempt to establish a communications session. Instead, the broadcast signal may represent a “ping” or location indicator, such as transmitted by a cellular protocol. Optionally, the broadcast signal may represent a position or time stamp, such as transmitted in connection by a GPS transmitter.

The terms “wireless activity tracking apparatus” and “WLA tracking apparatus”, as used throughout, shall include routers, firewalls, cellular transceiver, GPS transceivers, wireless access point and other devices that afford access to a wireless environment and support at least one-way communication over the wireless environment. The wireless environment may represent a local area network, a private or public area network, a wide-area network, a cellular network, a GPS network or otherwise.

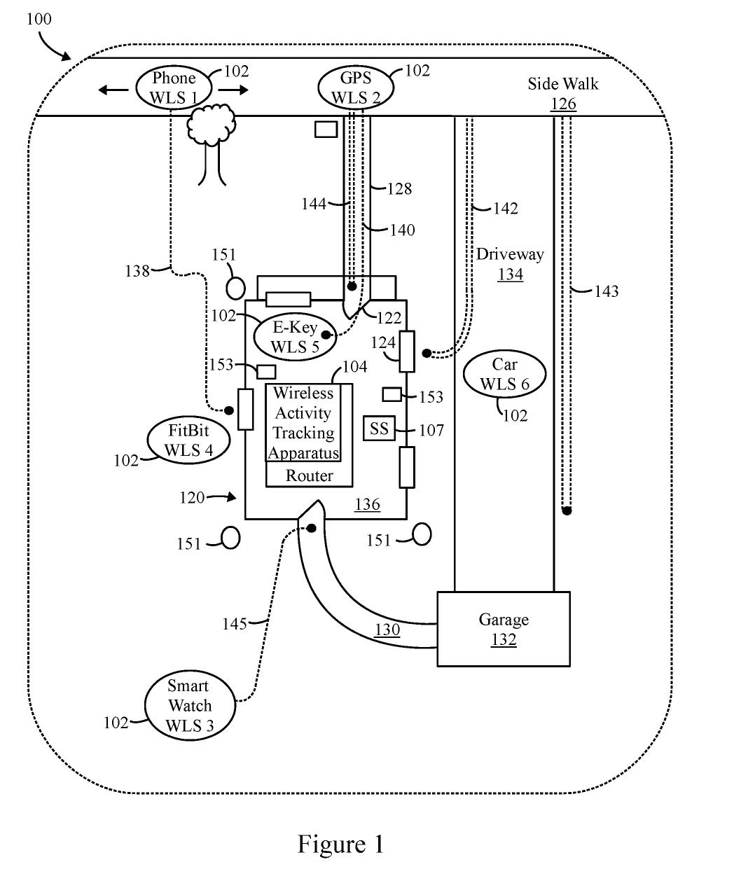

FIG. 1 is a functional block diagram illustrating a local wireless environment 100 that is tracked in accordance with embodiments herein. In embodiments, the local wireless environment 100 includes a wireless activity (WLA) tracking apparatus 104 that is configured to track wireless activity of one or more wireless mobile devices 102 that are within a range of the WLA tracking apparatus 104. The WLA tracking apparatus 104 may represent a network gateway to a network. The wireless mobile devices 102 move into and out of the range of the WLA tracking apparatus 104 following paths taken by individuals through the local wireless environment 100. The range/size of the local wireless environment 100 will vary based on the type of the wireless environment (e.g., local area network, cellular, GPS), the range of the WLA tracking apparatus 104, structures within the local wireless environment 100 that may interfere with wireless signals and the like.

As an example, the WLA tracking apparatus 104 may represent a router that creates a wireless local area network (WLAN) in accordance with the Institute of Electrical and Electronics Engineers (IEEE) 802.11 protocol. The mobile devices 102 connect to the WLAN in accordance to an IEEE 802.11 compatible security algorithm, such as, for example, Wi-Fi Protected Access (WPA), Wi-Fi Protected Access II (WPA2), or Wired Equivalent Privacy (WEP). The WLA tracking apparatus 104 can provide access to network for wireless devices connected to the wireless router, such as mobile devices 102, directly via bridging functionality integral to the WLA tracking apparatus 104, or in conjunction with bridging functionality, not shown, that is accessible by the WLA tracking apparatus 104. Network can be, for example, a cellular network, a local area network (LAN), a wide area network (WAN) such as the Internet, or a combination of the two, and can include wired, wireless, or fiber optic connections. While the WLA tracking apparatus 104 may provide access to a network, the WLA tracking apparatus 104 performs the wireless activity tracking operations described herein while denying the mobile devices 102 access to the LAN, WAN, cellular network and the like. The WLA tracking apparatus 104 performs the wireless activity tracking operations described herein without (or at least before) establishing a communications session with the mobile devices 102.

In the example of FIG. 1, the local environment 100 includes a residential premise 120 that includes a front door 122, windows 124, a rear door 136, a rear walk 130 to a garage 132, and a private driveway 134. A front walkway 128 leads from a sidewalk 126 to a front porch and the front door 122. The sidewalk 126 is located next to a public road. In accordance with embodiments herein, security methods, devices and computer program products are provided that locate potential intruders, or more generally unauthorized individuals. The premise 120 may include a security system 107 that includes various sensors, locks etc. For simplicity, only cameras 151 and motion sensors 153 are illustrated. However, the security system 107 may include one or more door/window sensors, motion sensors, glass break sessions, door/window locks, thermostat controls, light controls, cameras and the like. The embodiments identify the unauthorized individuals utilizing wireless activity, without normal wireless activity resulting in false alerts. Embodiments herein use wireless identifiers to detect and track typical/normal paths taken by mobile devices 102 (and thus users carrying such mobile devices) when within a desired proximity of the local environment 100 that includes the premise 120. Various alerts may be generated when wireless activity indicates that a mobile device 102 has followed an atypical/abnormal path and/or crossed virtual boundaries that define restricted zones related to the premise 120.

As one example, the individual carrying a smart phone or other wireless mobile device may walk along the sidewalk 126 or other public area along a boundary of the home or personal property. In some instances, it may be normal for pedestrians to walk through portions of a homeowner's yard (e.g., when the sidewalk 126 is blocked, covered in snow or ice). Embodiments herein afford the ability to define (automatically or manually) acceptable/normal predetermined routes through a homeowner's yard. Thus, when the WLA tracking apparatus 104 detects wireless activity for an un-known smart phone, the WLA tracking apparatus 104 may “watch” the path followed by the smart phone and record the path in an activity log. So long as the smart phone follows an acceptable predetermined route, the WLA tracking apparatus 104 would not raise an alert.

However, in the event that the WLA tracking apparatus 104 identifies that the wireless activity indicates that the mobile device 120 (and thus individual) in the foregoing example diverges from the predetermined route (e.g., walking toward a house window 124 or rear door 136), the WLA tracking apparatus 104 may generate an alert. For example, generation of the alert may include outputting the alert to an audible system (e.g., alarm sirens), outputting the alert to an additional device (e.g., sending the alert to a remote security monitoring service, security monitoring server, an individual's mobile device, etc.). Additionally or alternatively, the WLA tracking apparatus 104 may identify when the mobile device crosses a threshold distance from the premise 120. When an atypical path is identified from the wireless activity, the WLA tracking apparatus 104 generates an alert indicating that an individual has varied from normal paths taken by other individuals or acceptable/normal predetermined routes and update the activity log accordingly.

FIG. 1 illustrates various types of mobile devices 102 located at various positions about the premise 120 along with examples of paths that individuals may follow to relative to the premise 120. For example, an individual with a cellular phone (denoted as WLS1) may be walking along the sidewalk 126, while another individual on the sidewalk 126 may be carrying a mobile device with GPS functionality (WLS2). Additionally or alternatively, an individual, with a Fitbit device (WLS4), may leave the sidewalk 126 to approach a side window by walking along path 138 through the yard. Additionally or alternatively, an individual may approach the premise 120 by walking up the front walkway 128 along path 140 and utilize an electronic key (WLS5) to unlock the front door 122 and enter an entry way of the premise 120. Additionally or alternatively, an individual with a smart watch (WLS3) may approach the rear door 136 by climbing over a fence and entering through a backyard as denoted by path 145. Additionally or alternatively, an individual may pull into the driveway 134 with an automobile (WLS6) that includes a wireless transmitter (e.g., a smart car, a cellular transmitter, a GPS device, etc.).

As explained herein, embodiments define and store predetermined “limited access” routes 142-144 that are available for certain types of individuals who are afforded limited access. For example, routes 142 and 144 may be defined as delivery routes, for which limited access is granted to WLS associated with delivery individuals who pick up and drop off packages. As another example, the route 143 may be defined as a public service route, such as between the street and a location where garbage, recycle and yard waste bins are picked up, dumped and returned. One or more WLS associated with public service individuals are granted access to the limited access public service route 143. It is recognized that numerous other predetermined routes may be defined. The limited access routed 142-144 represent restricted zones.

Additionally or alternatively, embodiments herein may define predetermined suspect routes as restricted zones, such as walking toward a side window, a backyard, or jumping a fence or gate, instead of going to a front door. The predetermined suspect route may be defined by designating a physical region of a premise as the restricted zone. (e.g., a section of yard, section of property within a property boundary). Additionally or alternatively, the restricted zone may be defined as a distance from a reference point, such as 3-5 feet from a window or back door). When the wireless activity is determined to correspond to a predetermined suspect route, a higher level alert may be generated by the WLA tracking apparatus 104, as compared to an unknown individual simply approaching a front door, as the predetermined suspect route is extremely atypical for an unknown person. Additionally or alternatively, certain individuals and groups of individuals (e.g., family and friends) may be defined as exceptions that are authorized to follow predetermined suspect routes.

Public, limited access, suspect and other routes, as well as general wireless activity, may be learned or programmed in various manners. For example, embodiments herein may utilize a frequency in which a wireless mobile device 102 travels within a range of the WLA tracking apparatus 104, to identify various aspects herein. For example, embodiments may determine frequent paths (e.g., public routes) taken by nearby pedestrians, drivers, runners, etc. proximate to a premise. The frequent paths may include easements, such as common hallways within an apartment or office building, common areas in a multi-dwelling building, office complex and the like, roads, paths, sidewalks, etc. Embodiments herein may define boundaries or “lines in the sand” that people typically do not cross. For example, it may be normal for a trash collector to pick up trash from within a driveway or an area along a garage, but uncommon for the trash collector to walk further into the driveway or into other areas of the backyard. The frequent paths may be added to a learning log as public access routes that are outside restricted zones.

Additionally or alternatively, the restricted zones may be defined by presenting a birds eye view of the local wireless environment 100 on a graphical user interface of a computing device and allowing the user to designate the predetermined route, such as by “clicking on” start and end points, “clicking and dragging” a cursor between start and end points, drawing a box around a restricted zone extending between the start and end points and the like. The user entries are saved in a learning log. Additionally or alternatively, the predetermined routes may be defined by placing the WLA tracking apparatus 104 in a learning mode. A user may direct the WLA tracking apparatus 104 to track the user's WLS. The user may start at a location on the sidewalk and instruct the WLA tracking apparatus 104 to begin tracking a WLS route as the user walks along a predetermined route of interest, such as from the sidewalk into the yard where trash cans are placed for the garbage truck to pick up. As another example, the user may walk from the sidewalk up a front walkway and into an entry area of the home where a delivery person is authorized to use an electronic key to open the door and pickup/drop off packages. The user may use a mobile device 102 to enter start and end points for the predetermined route as the user traverses the route.

Additionally or alternatively, when a predetermined route is defined, a user may enter information defining the class of access to afford the route. Non-limiting examples of classes of access include complete access, full exterior access, entry area access, delivery route routes, garbage routes, utility/service routes, none and the like.

Additionally or alternatively, the predetermined routes may be defined based on actual wireless activity collected over time in connection with individuals passing through the local environment 100. For example, the WLA tracking apparatus 104 may collect wireless activity for a select period of time (e.g., day, week, month), including WLS and paths followed by the WLS. The WLA tracking apparatus 104 may then present the paths and WLS on the graphical user interface, such as through a graphical model of a birds eye view of the premise 120 (e.g., similar to FIG. 1). Optionally, the birds eye view may be obtained from an aerial map service, such as a Google® map application.

Embodiments identify, based on frequency, specific wireless signatures of wireless mobile devices, such as for individuals that may walk into a property owner's lot on a frequent or standard periodic basis. For example, neighbors may walk to an individual's front door to drop off deliveries, when an individual is not at home. Embodiments characterize the wireless signature of neighbor's mobile devices to be normal for approaching a front door when the homeowner is away, whereas other wireless signatures of non-neighbors would be considered abnormal to approach a front door when a homeowner is away. Embodiments identify zones or locations on a home or other premise that are typically not approached. For example, it may be abnormal to approach a window, versus a door. As another example, it may be abnormal to approach a rear door, instead of a front door. As another example it may be abnormal to approach a switch box power panel for a home, office or other premise.

Additionally or alternatively, the WLA tacking device 104 may communicate over a local area network with security cameras 151 and/or sensors 153 (e.g., motion sensors, glass break detectors, etc.) that monitor the local environment 100. The security cameras 151 record video data for corresponding fields of view. The cameras 151 may be activated by motion and/or by other sensors 153. The cameras 151 may divide the field of view into sections that can be separately and individually masked for triggered actions. The WLA tracking apparatus 104 may utilize tracking of wireless activity to turn on and off “squares” within a viewing area of a security camera 151. For example, certain individuals and corresponding wireless signatures that are known to be of low risk may be identified and the corresponding portion of a security camera turned off to avoid motion by the known individual from activating a video system and unnecessary recording video data. Accordingly, wireless activity of known signatures may be utilized to configure video recording systems to ignore certain areas while the known individual is present.

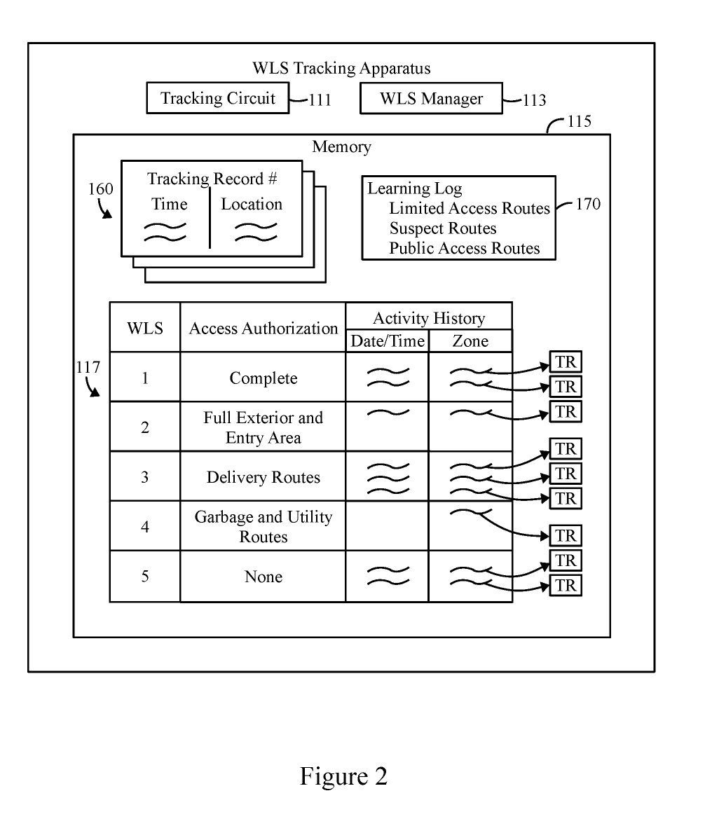

FIG. 2 illustrates a block diagram of a WLA tracking apparatus 104 (also referred to as an apparatus) formed in accordance with embodiments herein. The WLA tracking apparatus 104 includes a tracking circuit 111 that is configured to detect wireless activity in proximity to the local environment 100. For example, the tracking circuit 111 may be connected to an antenna that is located within or mounted on a housing of the WLA tracking apparatus 104. Additionally or alternatively, multiple antenna may be attached to the WLA tracking apparatus 104. The multiple antenna may be physically located within a common housing of the WLA tracking apparatus 104, or distributed at multiple points within the premise 120. For example, one antenna may be provided at the WLA tracking apparatus 104, while one or more additional antenna may be provided within repeaters and the like.

The tracking circuit 111 tracks a detected path of the wireless device based on one or more characteristics of a signal broadcast from the mobile device 102. For example, the tracking circuit 111 may monitor, as the characteristic of interest, a signal strength of signals broadcast from a mobile device 102 (as received at the tracking circuit 111). The tracking circuit 111 determines a distance to the mobile device 102 based on the receive signal strength and reference receive signal strengths. For example, during the learning mode, the tracking circuit 111 may perform a calibration operation in which the tracking circuit 111 collects multiple signal strength measurements of signals broadcast from a mobile device 102 of a user (e.g. homeowner) while the user moves to different locations inside and outside the premise 120 and/or different distances from the WLA tracking apparatus 104. As the user moves to different locations inside and outside the premise 120, the tracking circuit 111 may collect corresponding signal strength measurements. The user may manually enter, or the WLA tracking apparatus 104 may automatically calculate, distances between the tracking circuit 111 and the mobile device 102 in connection with each signal strength measurement. As one non-limiting example, the WLA tracking apparatus 104 may direct a user (e.g. through a graphical user interface on the mobile device while operating a learning mode application) to move predetermined distances from the WLA tracking apparatus 104. Additionally or alternatively, the WLA tracking apparatus 104 may direct the user through the GUI of the mobile device 102 to move to predetermined locations within or about the premise 120 (e.g. stand or move outside a front first-floor window, stand or move outside a rear window, stand or move outside the front door, stand or move outside the back door, stand or move in the driveway, stand or move by the mailbox, stand or move by the trash cans, stand in the living room, kitchen, bedroom). The user may utilize a learning mode application operating on the mobile device 102 in order to enter an indication, when the user (and the mobile device 102) are at predetermined distances from the WLA tracking apparatus 104 and/or at the predetermined locations within or about the premise 120. In response thereto, the tracking circuit 111 collects signal strength measurements in connection with each predetermined distance and/or location. The signal strength measurements and predetermined distances are then used later, by the tracking circuit 111 and/or WLS manager 113, in connection with tracking wireless activity of other mobile devices 102.

In the foregoing example, calibration signal strength measurements are generally collected in connection with a stationary mobile device 102. Additionally or alternatively, the calibration signal strength measurements may be collected while the user and mobile device 102 move. For example, the GUI of the mobile device 102 may direct the user to walk along a side of the premise 120 near a window. As another example, the user may be directed to begin at a location on a public sidewalk or outside of a property boundary, jump a fence or enter the property from some location other than a walkway, and move along an exterior of a building adjacent to one or more windows or private entrances. As the user performs the requested suspect movement, the tracking circuit 111 collects multiple calibration signal strength measurements, that are later used while monitoring wireless activity of unknown mobile devices 102.

Additionally or alternatively, the WLA tracking apparatus 104 may request the user to enter a distance between the WLA tracking apparatus 104 and the user each time a signal strength measurement is collected. Additionally or alternatively, the WLA tracking apparatus 104 may communicate with the user's mobile device 102 to automatically obtain GPS accordance information from the user's mobile device 102 each time the tracking circuit 111 collects a signal strength measurement. It is recognized that other techniques may be utilized to calibrate the WLA tracking apparatus 104 in connection with measuring distances to mobile devices.

Optionally, the tracking circuit 111 may track positions of mobile devices 102 based on signal characteristics other than signal strength.

The wireless activity including a wireless signature of the mobile wireless device 104. For example, when the tracking circuit 111 identifies wireless activity from a mobile device 102, the tracking circuit 111 creates a tracking record 160 uniquely associated with the mobile device 102. The tracking circuit 111 monitors the wireless activity and repeatedly calculates locations of the mobile device 102 over a period of time. The tracking circuit 111 stores, in the tracking record 160, a unique identifier for the mobile device 102 along with the path followed by the mobile device 102. The unique identifier may represent the WLS broadcasts by the mobile device 102. Optionally, the tracking circuit 111 may assign a random unique identifier for the tracking record 160.

The WLA tracking apparatus 104 also includes a WLS manager 113, defined by one or more processors executing program instructions, that performs operations described herein. The WLS manager 113 is configured to determine whether the detected path of the mobile device 120 indicates an unauthorized physical presence relative to a restricted zone related to the local environment 100. The WLS manager 113 generates one or more alerts when the path indicates the unauthorized physical presence of the wireless device relative to the restricted zone. The WLS manager 113 manages access authorization for the mobile devices 102. The access authorization may be modified based on time of day, whether an owner/manager is present at the premise, whether an unsupervised child is present at the premise and other security considerations. The WLS manager 113 may also manage the access authorization, associated with a particular WLS, based on past behavior of the WLS. For example, when a WLS is normally detected on certain days of the week and/or at certain types of day, but then is detected at an unusual time of day/date, the WLS manager 113 may reduce or deny the access authorization assigned to the WLS, and treat the WLS as an unauthorized physical presence.

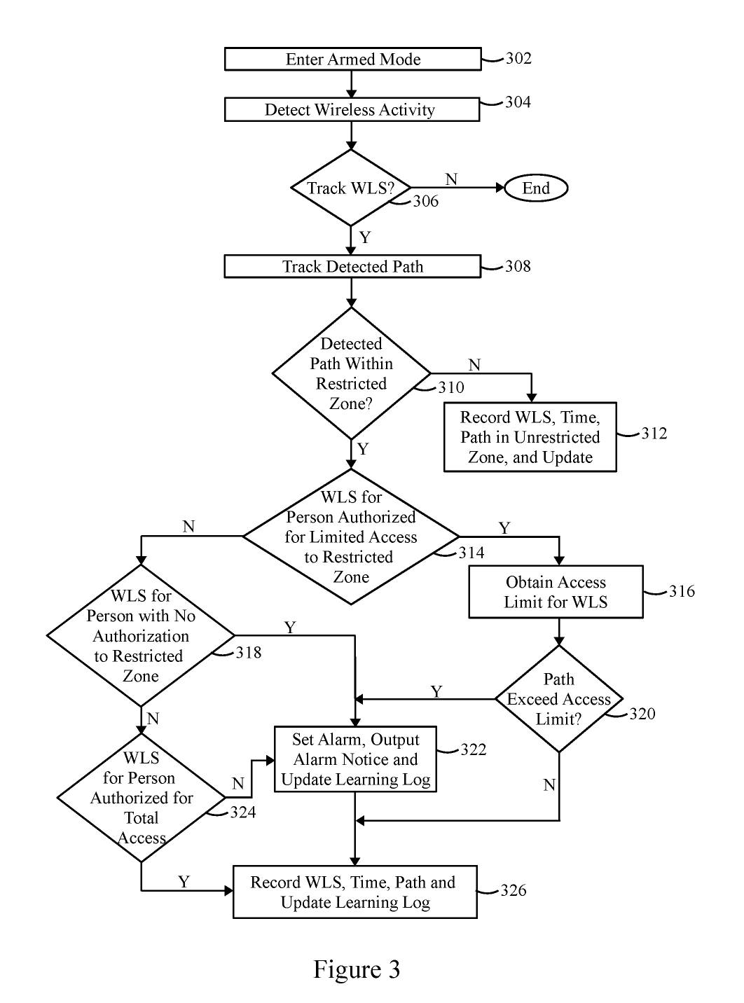

For example, generation of the alert may include the WLS manager 113 outputting the alert to an audible system (e.g., alarm sirens), outputting the alert to an additional device (e.g., sending the alert to a remote security monitoring service, security monitoring server, an individual's mobile device, etc.). The alarm may be stored on the activity log and/or a remote log, such as at a remote security monitoring system. The alarm may be pushed to a mobile device carried by one or more designated individuals (e.g., a home owner, business owner/manager, security guard, police station, etc.). For example, in the activity log 117 may maintain all or some paths followed by any WLS that are analyzed in accordance with the operations of FIG. 3 to allow the system to learn more about wireless activity within the area and in connection with individual WLS. Additionally or alternatively, the WLS manager 113 may elevate a status of the security system 107. For example, when the one or more processors determine that an unauthorized WLS is within a restricted zone, and all or a portion of the premise security system 107 is turned off, the processor(s) may turn on all or the corresponding portion of the premise security system 107. Optionally, the processor(s) may lock one or more doors, windows, etc. that were not already locked, turn on one or more motion detectors, turn on exterior and/or interior lights, turn on exterior and/or interior video cameras, activate motion detection on exterior and/or interior cameras, and the like.

The WLA tracking apparatus 104 may include or have access to memory 115 that stores, among other things, an activity log 117. The log 117 define access settings to be implemented in connection with different WLS. The WLA tracking apparatus 104 stores and manages tracking records 160, one or more learning logs 170 and one or more activity logs 117. The tracking records 160, learning log 170 and activity log 117 may be stored in memory 115 locally and/or remotely from the WLA tracking apparatus 104.

Each tracking record 160 is associated with a particular tracking event for one mobile device 102 (and corresponding WLS). The tracking circuit 111 creates and updates individual tracking records 160 in connection with each mobile device 102.

The learning log 170 is utilized to define one or more restricted zones in connection with the local environment 100. A restricted zone may correspond to a single predetermined route and/or multiple similar predetermined routes. Additionally or alternatively, a restricted zone may correspond to a physical region, without regard for a particular path followed through the region and/or without regard for any predetermined routes through the region. Nonlimiting examples of restricted regions represent predetermined limited access routes and predetermined suspect routes. Optionally, the learning log 170 may also store public access routes (e.g., a sidewalk), for which all individuals, all WLS and all mobile devices have access. The WLS manager 113 may enter a learning mode to initially populate and periodically update the learning log 170. Optionally, the WLS manager 113 may update the learning log throughout operation, without a need to enter any particular mode in connection there with.

The activity log 117 retains a record in connection with individual WLS. As nonlimiting examples, the activity log 117 may maintain access authorization levels assigned to individual WLS, as well as an activity history. Nonlimiting examples of access authorization levels include complete access, full exterior access, entry area access, delivery route access, garbage route access, utility route access and no access. The foregoing examples of access authorization levels are somewhat self-explanatory. For example, complete access may be a provided to a homeowner, business owner, family member, senior manager and the like. Full exterior access may be afforded to trusted neighbors, friends of children, and the like. Entry access may be afforded to delivery services that are provided an electronic key to drop off and pick up packages. Delivery route access may be afforded to individuals who pick up and drop off packages at an exterior of the premises 120. Garbage and utility route access may be afforded to garbage and utility service individuals. It is recognized that the foregoing are nonlimiting examples of authorization levels. Alternative or additional authorization levels may be afforded based upon the nature of the premise and the types of individuals may approach the premise with legitimate motives.

The activity history may be maintained in various manners. For example, the activity history may maintain a record of each time and date that a WLS was detected, along with an indication of which is owns or paths were followed by the WLS. For example, the activity history may record a list of restricted zones entered by a mobile device associated with a particular WLS, along with the date and time of such entries. Additionally or alternatively, the activity history may maintain the individual tracking records 160 created by the tracking circuit 111. The tracking records associated with unknown WLS or WLS having limited access may be maintained indefinitely or for long periods of time. The tracking records associated with known WLS and/or WLS having complete or larger levels of access may be maintained for short periods of time or not at all.

Additionally or alternatively, the WLS manager 113 may manage security cameras by turning motion sensitivity on and off for sections (e.g., squares) within a viewing area of a camera. For example, when the camera detects motion, the camera would normally begin recording video data. The learning log 170 and/or activity log 160 may maintain a record of WLS for mobile devices of individuals that are not to trigger motion related actions of the security camera. known to be of low risk, also referred to as motion-masked WLS. When the WLS manager 113 identifies a motion-masked WLS, the WLS manager 113 may determine a sector or portion of a viewing area of the camera that includes the individual carrying the mobile device. The WLS manager 113 directs the camera to mask motion related actions for the designated sector of the viewing area. In response, the camera ignores motion within the corresponding portion of the field of view of the camera and does not turn on recording (or another motion related action) even when motion is detected by an individual with the motion-masked WLS. Accordingly, wireless activity of known signatures may be utilized to configure video recording systems to ignore certain areas while the known individual is present.

FIG. 3 illustrates a process for detecting an unauthorized physical presence based on wireless activity in accordance with embodiments herein.

At 302, the process enters an active or armed mode in which wireless signatures are monitored for physical activity that is unusual or otherwise un-expected. For example, the process may be initiated by a user input, such as when a user (locally or remotely) arms a premise security system and/or the WLA tracking apparatus 104. As another example, the process may be automatically initiated, such as based on preprogrammed times, when the WLA tracking apparatus 104 determines that a device having an authorized user WLS (e.g., the homeowner) has left the range of the WLA tracking apparatus 104 and/or based on other criteria.

At 304, one or more processors of the tracking circuit 111 begin to detect wireless activity in proximity to the premise 120. The detection of wireless activity occurs before and without establishing a communications link with mobile device(s) 102. For example, the tracking may be performed in connection with a local area network (LAN) while a route of the LAN denies the wireless device access to the LAN. The wireless activity includes a WLS of one or more mobile wireless devices. The processors detect wireless activity by, among other things, searching for one or more WLS of mobile wireless devices within a range of the WLA tracking apparatus(s) 104.

At 306, an optional operation is included, where the one or more processors of the WLS manager 113 determine whether the wireless device has a WLS that should be tracked. For example, when a WLS indicates that the wireless device corresponds to an individual who is authorized to be in or near the premise (e.g., an owner, friend or family member of a residential site, a manager or employee of a business at a commercial, government or educational site). When the processors determine to not track a path of the WLS, the process ends. Alternatively, when the processors determine to continue tracking the WLS, the process moves to 308.

At 308, the one or more processors of the WLS manager 113 track a path of the mobile device 102 based on one or more characteristics of a signal broadcast from the mobile device 102. The path may be tracked in various manners. For example, the tracking circuit 111 may determine the position through triangulation, range detection, signal strength, signal directionality and the like. At 308, the one or more processors record the path in a tracking record 160 in various manners. For example, the path may be recorded as a series of GPS or other physical location designators. Additionally or alternatively, the path may be recorded as a series of range measurements, series of signal strength measurements, series of directionality measurements and the like.

At 310, the one or more processors determine whether the path of the mobile device 102 is within a restricted zone related to the premise 120. For example, WLS manager 113 may compare a detected path with the public, limited access and suspect routes to determine whether the path indicates normal or abnormal activity. As explained herein, normal activity may include a physical presence of a mobile device 102 outside of a restricted zone, such as along a sidewalk, road, neighboring property boundary and the like. Abnormal activity may include a physical presence of a mobile device 102 within a restricted zone, such as near a window 124 or rear door 136 to a premise 120, within a private yard or other area, in a driveway 134, on a residence porch and the like. Additionally or alternatively, abnormal activity may be indicated by a path 138, 145 followed by the mobile device 102 while approaching the premise 120, such as approaching a premise over a fence, through a yard, from a back alley and the like. When the detected path is outside a restricted zone, the path does not indicate an unauthorized physical presence, flow branches to 312. When the detected path is in a restricted zone, the path indicates a “potential” unauthorized physical presence, and flow branches to 314.

At 312, the one or more processors may update the activity log 117, such as by recording the WLS, a timestamp, a path taken by the mobile device 102, a path into or through a restricted zone, and the like.

At 314, the one or more processors determine whether the WLS is for a person authorized to have limited access to the restricted zone. When a determination is made at 314 that the WLS corresponds to a person authorized for limited access, flow moves to 316. Otherwise, flow moves to 318.

At 316, access limits are obtained for the WLS. For example, the activity log 117 may maintain a list of WLS for individuals who are authorized to be within the restricted zone and/or to follow predetermined routes, for certain limited purposes or time periods. For example, a mail person may be added to the activity log 117, alone or in combination with the designation of certain times of day for which the mail person should be present. The activity log 117 may also designate different WLS that are authorized for different restricted zones. For example, a residence or commercial office may utilize a service in which delivery personnel are provided with an electronic key that may open a locked door (and to disarm an alarm system) for a short period of time to allow the delivery person to pick up and drop off packages. The user log may designate the WLS of the delivery person to have access to a relatively small entry area immediately inside of a door and to permit the person to remain within entry area for a short period of time (e.g., 5-10 minutes) as is customary in connection with picking up and dropping off packages. As other examples, WLS associated with utility workers, garbage and recycle collection persons and the like may be added to the user log and approved to travel within certain zones or along predetermined routes relative to a premise, and/or on certain days/times.

At 320, the one or more processors determine whether a current path of the WLS remains within or exceeds the access limit as defined by the activity log 117. When the current path exceeds the access limit, flow moves to 322. When the current path does not exceed the access limit, flow moves to 326.

At 322, the one or more processors set one or more alarms and generate one or more alarm notices, as well as updating the activity log 117. For example, generation of the alert may include outputting the alert to an audible system (e.g., alarm sirens), outputting the alert to an additional device (e.g., sending the alert to a remote security monitoring service, security monitoring server, an individual's mobile device, etc.). The alarm may be stored on the activity log and/or a remote log, such as at a remote security monitoring system. The alarm may be pushed to a mobile device carried by one or more designated individuals (e.g., a home owner, business owner/manager, security guard, police station, etc.). For example, in the activity log 117 may maintain all or some paths followed by any WLS that are analyzed in accordance with the operations of FIG. 3 to allow the system to learn more about wireless activity within the area and in connection with individual WLS. Additionally or alternatively, at 322, the one or more processors may elevate a status of the security system 107. For example, when the one or more processors determine that an unauthorized WLS is within a restricted zone, and all or a portion of the premise security system 107 is turned off, the processor(s) may turn on all or the corresponding portion of the premise security system 107. Optionally, the processor(s) may lock one or more doors, windows, etc. that were not already locked, turn on one or more motion detectors, turn on exterior and/or interior lights, turn on exterior and/or interior video cameras, activate motion detection on exterior and/or interior cameras, and the like.

Returning to 314, when flow branches to 318, at 318, the one or more processors determine whether the WLS is for a user with no authorization to any restricted zone or any predetermined route. For example, the WLS may be compared to the activity log 117. When the current WLS is determined to have no authorization, flow branches to 322 where alarms are set, alarm notices are output and the activity log 117 is updated. Alternatively, when the current WLS is determined to have some authorization to the restricted zone, flow branches to 324.

At 324, the one or more processors may determine whether the WLS is authorized for total access to the restricted region and/or has no limits on predetermined routes. Optionally, the operation at 324 may be omitted entirely. When the determination at 324 indicates that the WLS is not authorized for total access, the potential exists that some type of error has arisen, in which case flow may branch to 322 where alarms are set and output. When the WLS is authorized for total access, flow continues to 326. At 326, the system updates the activity log 117 for the WLS, along with various related information of interest, such as the time of day, the path followed and the like.

While the foregoing example is provided in connection with one mobile device, it is recognized that the process of FIG. 3 may be implemented in connection with multiple mobile devices. For example, the detecting at 304 detects wireless activity of multiple mobile devices and the tracking at 308 tracks separate detected paths of multiple mobile devices utilizing the WLS of the corresponding mobile devices.

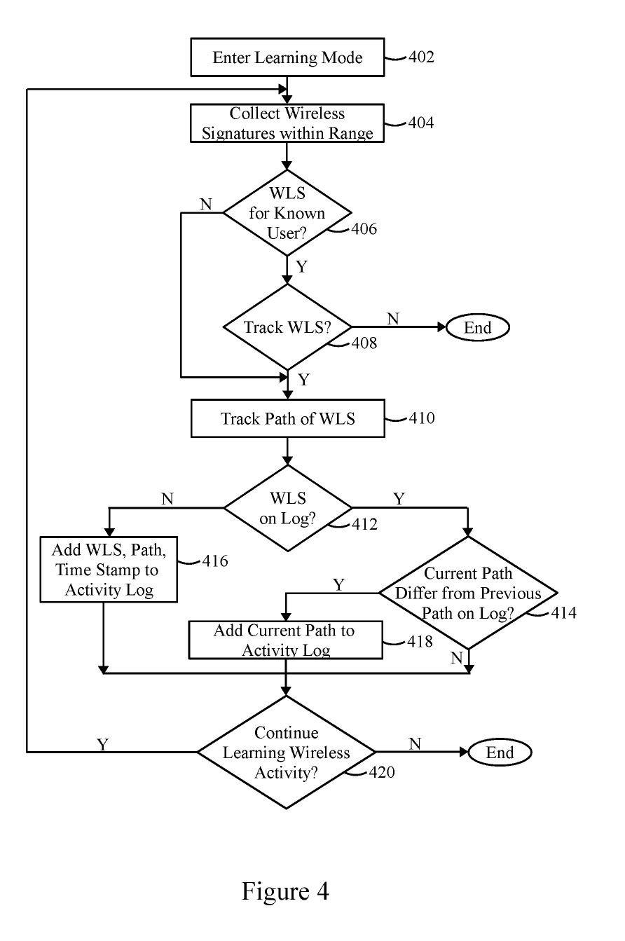

FIG. 4 illustrates a process for learning normal and abnormal wireless activity. At 402, one or more processors of the WLS manager 113 enter a learning mode. The learning mode may be entered when the WLA tracking apparatus 104 is initially installed, periodically thereafter, in response to user instructions and the like. Optionally, at 402, the WLS manager 113 may enter a calibration operation, as described above in connection with FIG. 2, whereby various calibration signal strength measurements are collected in connection with known distances to the WLA tracking apparatus 104 and/or in connection with designated locations within and around a premise 120.

At 404, the one or more processors detect wireless activity within the local environment 100 and collect wireless signatures for wireless mobile devices 102. The WLS for the mobile devices 102 are used to separately track movement of each mobile device 102. At 406, the one or more processors may begin analyzing each WLS to determine if any WLS corresponds to a known user. For example, the activity log 117 may be reviewed to determine whether the current WLS are already recorded. When the WLS corresponds to a known user, flow moves to 408. At 408, the one or more processors of the WLS manager 113 determine whether the WLS should be tracked. For example, a WLS may correspond to a known user that represents a neighbor, employee, delivery person, utility worker and the like. At 408, the one or more processors made determine that, even though the WLS is known, the WLS should be tracked anyway. Alternatively, when a WLS corresponds to a known user, such as a family member, business manager, business owner, at 408, the process may determine to not track the WLS.

At 410, the one or more processors collect additional wireless activity in connection with one or more current WLS. The wireless activity is utilized to define and track a path followed by the WLS. The operation at 410 may be carried out for a predetermined period of time based on various criteria. For example, one or more WLS may be tracked the entire time the WLS(s) is within the range of the tracking system. Additionally or alternatively, the WLS may be tracked until the process determines that the WLS is following a path leading away from a premise.

At 412, the one or more processors determine whether activity log 117 already includes the WLS currently being tracked. When the current WLS are already on an activity log 117, flow branches to 414. Otherwise, flow branches to 416. At 414, the one or more processors determine whether the current path of the WLS differs from a previous path or paths recorded on the activity log 117 for the current WLS. When the current path differs from previously recorded paths, flow branches to 418. Otherwise, flow branches to 420. At 418, the activity log 117 is updated to add the current path. The update to the activity log 117 may include the addition of the current path in place of, or in addition to, previously recorded paths.

Returning to 412, when flow branches to 416, the one or more processors add the current WLS to the activity log 117, along with the path followed by the WLS and a timestamp at which the wireless activity occurred. Thereafter, the process continues to 420. At 420, the one or more processors determine whether to remain in the learning mode to monitor for additional wireless activity. If so, flow returns to 404. Otherwise the process ends.

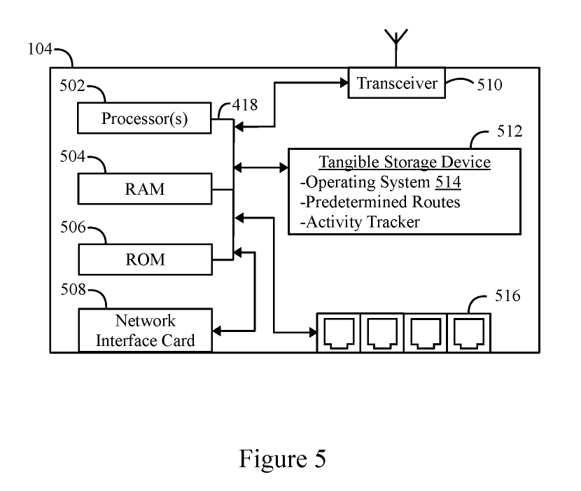

FIG. 5 is a block diagram of components of WLA tracking apparatus 104 in accordance with embodiments herein. The WLA tracking apparatus 104 can include one or more processors 502, one or more computer-readable RAMs 504, one or more computer-readable ROMs 506, one or more tangible storage devices 512, a network interface card 508, a transceiver 510, and optionally one or more network ports 516, all interconnected over a communications fabric 518. Communications fabric 518 can be implemented with any architecture designed for passing data and/or control information between processors (such as microprocessors, communications and network processors, etc.), system memory, peripheral devices, and any other hardware components within a system.

One or more operating systems 514, predetermined routes and activity tracking programs are stored on computer-readable tangible storage device 512 for execution or access by one or more processors 502 via one or more RAMs 504 (which typically include cache memory). In the illustrated embodiment, computer-readable tangible storage device 512 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The WLA tracking apparatus 104 will typically include a network interface card 508, such as a TCP/IP adapter card. The programs on network WLA tracking apparatus 104 can be downloaded to the wireless router from an external computer or external storage device via a network (for example, the Internet, a local area network or other, wide area network or wireless network) and network interface card 508. The programs can then be loaded into computer-readable tangible storage device 512. The network may comprise copper wires, optical fibers, wireless transmission, routers, firewalls, switches, gateway computers and/or edge servers.

### CLOSING STATEMENTS

Before concluding, it is to be understood that although e.g., a software application for undertaking embodiments herein may be vended with a device such as the system, embodiments herein apply in instances where such an application is e.g., downloaded from a server to a device over a network such as the Internet. Furthermore, embodiments herein apply in instances where e.g., such an application is included on a computer readable storage medium that is being vended and/or provided, where the computer readable storage medium is not a carrier wave or a signal per se.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. A method, comprising:
under control of one or more processors configured with executable instructions;
detecting wireless activity of a mobile device in proximity to a local environment;
tracking a detected path of the mobile device based on one or more characteristics of a broadcast signal from the mobile device;
determining whether the detected path of the mobile device indicates an unauthorized physical presence of the mobile device relative to a restricted zone related to the local environment; and
generating an alert in response to the detected path indicates the unauthorized physical presence of the mobile device relative to the restricted zone.

2. The method of claim 1, wherein the detecting comprises detecting wireless activity of multiple mobile devices and the tracking comprises tracking separate detected paths of the multiple mobile devices utilizing wireless signatures of the corresponding mobile devices.

3. The method of claim 1, wherein the detecting comprises detecting a wireless signature (WLS) of a mobile device, wherein the WLS is assigned a limited access authorization level and wherein the determining comprises determining whether the detected path follows a limited access route corresponding to the limited access authorization level.

4. The method of claim 1, further comprising collecting wireless activity over time in connection with multiple mobile devices passing through the local environment, defining one or more predetermined routes based on the wireless activity collected for the multiple mobile devices, wherein the determining comprises comparing the detected path to one or more predetermined routes associated with the restricted zone.

5. The method of claim 1, wherein the detecting, tracking and determining are performed while denying the mobile device access to a wireless network.

6. The method of claim 1, wherein the mobile device is one or more of a phone, wearable device or tablet device.

7. The method of claim 1, wherein the detecting comprises detecting a request to connect from the mobile device, denying the request to connect and thereafter continuing the detecting of the wireless activity, the request to connect including a wireless signature of the mobile device.

8. The method of claim 1, wherein the determining comprises characterizing the detected path as normal activity or abnormal activity.

9. An apparatus, comprising:
a tracking circuit to detect wireless activity of a mobile device in proximity to a local environment, the tracking circuit to track a detected path of the mobile device based on one or more characteristics of a broadcast signal from the mobile device;
one or more processors;
a memory storing program instructions accessible by the one or more processors, wherein, responsive to execution of the program instructions, the one or more processors to perform the following:
determining whether the detected path of the mobile device indicates an unauthorized physical presence of the mobile device relative to a restricted zone related to the local environment; and
generating an alert in response to the detected path indicates the unauthorized physical presence of the mobile device relative to the restricted zone.

10. The apparatus of claim 9, wherein the one or more processors determine whether the detected path follows a limited access route corresponding to a limited access authorization level.

11. The apparatus of claim 9, further comprising a network transceiver to communicate with a wireless network, wherein the network transceiver includes the tracking circuit to track the wireless activity in connection with granting access to the wireless network, and the one or more processors to deny the mobile device access to the wireless network while the one or more processors determines whether the detected path indicates the unauthorized physical presence.

12. The apparatus of claim 9, wherein the tracking circuit is configured to detect a wireless signature (WLS) of a mobile device prior to or independent of i) establishing access to a wireless network or ii) establishing a communications session, and wherein the one or more processors detect, within the wireless activity, a request to connect from the mobile device, the request to connect including the WLS for the mobile device.

13. The apparatus of claim 9, wherein the one or more processors store and manage one or more of i) tracking records, ii) a learning log and iii) an activity log.

14. The apparatus of claim 13, wherein the tracking circuit is configured to detect a wireless signature (WLS) of the mobile device that is transmitted by the mobile device without or before establishing a communication session, and wherein the tracking records are associated with tracking events for the mobile device and the corresponding WLS.

15. The apparatus of claim 13, wherein the learning log defines a restricted zone in connection with the local environment, the restricted zone corresponding to a predetermined route.

16. The apparatus of claim 13, wherein the wireless activity including a wireless signature (WLS) of a mobile device and wherein the activity log maintains access authorization levels assigned to individual WLS, and an activity history, the access authorization levels include one or more of complete access, full exterior access, entry area access, delivery route access, garbage route access, utility route access and no access.

17. A computer program product comprising a non-transitory non-signal computer readable storage medium comprising computer executable code to:
detect wireless activity of a mobile device in proximity to a local environment;
track a detected path of the mobile device based on one or more characteristics of a broadcast signal from the mobile device;
determine whether the detected path of the mobile device indicates an unauthorized physical presence of the mobile device relative to a restricted zone related to the local environment; and
generate an alert when the detected path indicates the unauthorized physical presence of the mobile device relative to the restricted zone.

18. The computer program product of claim 17, wherein the computer executable code further characterizes the detected path as normal activity or abnormal activity.

19. The computer program product of claim 17, wherein the computer executable code further compares the detected path to one or more predetermined routes associated with the restricted zone.

20. The computer program product of claim 17, wherein the computer executable code wherein the tracking is performed in connection with a wireless network, and wherein the detecting, tracking and determining are performed while denying the mobile device access to the wireless network.

21. The apparatus of claim 9, wherein the one or more processors are to collect wireless activity over time in connection with multiple mobile devices passing through the local environment, and to track detected paths of the multiple mobile devices based on the wireless activity collected for the multiple mobile devices, the apparatus further comprising a display to present, through a graphical user interface, a graphical model of the local environment and to present the detected paths on the graphical model.

22. The apparatus of claim 9, wherein the tracking circuit detects the wireless activity before and without establishing a communications link with the mobile device.
